(19) United States
(12) Patent Application Publication
(10) Pub. No.: US 2018/0293091 A1
(43) Pub. Date: Oct. 11, 2018

(54) DISPLAY CONTROL APPARATUS AND DISPLAY CONTROL METHOD

(71) Applicant: MITSUBISHI ELECTRIC CORPORATION, Tokyo (JP)

(72) Inventor: Nobumasa SAWATARI, Tokyo (JP)

(73) Assignee: MITSUBISHI ELECTRIC CORPORATION, Tokyo (JP)

(21) Appl. No.: 15/570,706

(22) PCT Filed: Jul. 15, 2015
(86) PCT No.: PCT/JP2015/070239

§ 371 Date: Oct. 30, 2017

(51) Int. Cl. G06F 9/451; G06F 3/0482; G09G 5/32; G09G 5/22

(52) U.S. Cl. CPC G06F 9/454; G06F 3/0482; G09G 5/246; G09G 5/225; G09G 5/32

(57) ABSTRACT

In the present invention, layout information about each screen layout is separated into a plurality of display elements, and is stored in a plurality of databases for the respective display elements in association with a language selection flag. The plurality of databases include an alignment/progression database and a component position database. The alignment/progression database stores alignment information and progression information. The component position database stores component position information. A controller acquires layout information appropriate to the language selection flag from each database, and controls a display device such that display information is displayed based on the acquired layout information.

### TECHNICAL FIELD

The present invention relates to a display control apparatus and a display control method that control a display device capable of displaying information with the same content in a plurality of screen layouts for a plurality of different languages.

### BACKGROUND ART

There is a display device capable of displaying information with the same content in a plurality of screen layouts for a plurality of different languages. A technique for changing a language to be displayed in such a display device is disclosed in, for example, Patent Document 1. In a technique disclosed in Patent Document 1, when a language change command is received, a displayed form is switched from a currently selected language to another language among a plurality of languages.

The plurality of languages include, for example, Western languages such as English, and Arabic. A screen layout for Arabic (which may be hereinafter referred to as an “Arabic screen”) and a screen layout for languages other than Arabic, such as Western languages (which may be hereinafter referred to as a “non-Arabic screen”) have the following differences.

On the Arabic screen, the positions of components such as text are left-right reversed from those of the non-Arabic screen for languages other than Arabic such as Western languages. On the Arabic screen, alignment indicating the position of characters displayed in a text component and progression indicating the order of characters displayed in the text component are also left-right reversed from those of the non-Arabic screen.

In addition, on the Arabic screen, as an image such as an icon, an image dedicated for the Arabic screen is often used. In this case, the image dedicated for the Arabic screen needs to be implemented for each display element forming a screen layout. When a plurality of screens are prepared as Arabic screens, a plurality of images dedicated for the Arabic screens need to be implemented.

### PRIOR ART DOCUMENT

### Patent Document

Patent Document 1: Japanese Unexamined Patent Application Publication (Translation of PCT Application) No. 2004-521409

### SUMMARY OF INVENTION

### Problems to be Solved by the Invention

As described above, on the Arabic screen, various display elements differ from those of the non-Arabic screen. Therefore, a display control apparatus that controls a display device capable of supporting both the Arabic screen and the non-Arabic screen has a problem of complex data management and implementation. In addition, when a screen layout is changed, since the entire screen layout needs to be changed, there is a problem that the screen layout cannot be easily changed.

In addition, on a special screen, although the position of a text component is not changed, the alignment and progression of a character string may be changed. As such, there is a case in which a determination as to whether display elements are adaptive needs to be made for each screen. In this case, display control by the display control apparatus may become more complex.

An object of the present invention is to provide a display control apparatus and a display control method that can easily switch a screen layout to one appropriate to a display language and can easily design and change a screen layout.

### Means for Solving the Problems

A display control apparatus of the present invention is a display control apparatus that controls a display device capable of displaying display information with same content to be displayed, in a plurality of screen layouts for a plurality of different languages, the display control apparatus including: an acquiring unit that acquires a language selection flag indicating which one of the plurality of languages has been selected as a display language to be displayed on the display device; a storage including a plurality of databases, the plurality of databases separating layout information about each of the screen layouts into a plurality of display elements forming the screen layout, and storing, for the respective display elements, the layout information in association with the language selection flag; and a controller that acquires layout information appropriate to the language selection flag from each of the databases, and controls the display device such that the display information is displayed based on the acquired layout information, wherein the plurality of databases include: an alignment/progression database that stores alignment information and progression information among the plurality of display elements, the alignment information indicating a position of characters in a character display area in which the characters are to be displayed, and the progression information indicating order of the characters; and a component position database that stores component position information among the plurality of display elements, the component position information indicating positions, in the screen layouts, of components including the character display area.

A display control method of the present invention is a display control method that controls a display device capable of displaying display information with same content to be displayed, in a plurality of screen layouts for a plurality of different languages, the display control method including: separating layout information about each of the screen layouts into a plurality of display elements forming the screen layout, and storing the layout information in a plurality of databases for the respective display elements in association with a language selection flag indicating which one of the plurality of languages has been selected as a display language to be displayed on the display device; and acquiring, when the language selection flag is acquired, layout information appropriate to the acquired language selection flag from each of the databases, and controlling the display device such that the display information is displayed based on the acquired layout information, wherein when the layout information is stored in the plurality of databases, the layout information is stored in at least: an alignment/progression database that stores alignment information and progression information among the plurality of display elements, the alignment information indicating a position of characters in a character display area in which the characters are to be displayed, and the progression information indicating order of the characters; and a component position database that stores component position information among the plurality of display elements, the component position information indicating positions, in the screen layouts, of components including the character display area.

### Effects of the Invention

According to the display control apparatus of the present invention, the display control apparatus is configured to include an acquiring unit, a storage, and a controller. A language selection flag is acquired by the acquiring unit. The storage includes a plurality of databases. The databases separate layout information about each screen layout into a plurality of display elements and store, for the respective display elements, the layout information in association with the language selection flag. The controller acquires layout information appropriate to the language selection flag from each database, and controls a display device such that display information is displayed based on the acquired layout information. The plurality of databases in the storage include an alignment/progression database and a component position database. The alignment/progression database stores alignment information and progression information. The component position database stores component position information.

As described above, layout information appropriate to the language selection flag is acquired from the databases provided for the respective display elements in the storage. The display device is controlled such that display information is displayed based on the acquired layout information. By this, by changing the language selection flag, all pieces of layout information for each display element can be changed at once. Therefore, a screen layout can be easily switched to one appropriate to a display language. In addition, when a screen layout is designed, the design is performed on a per display element basis, and thus, the screen layout can be easily designed. In addition, when a screen layout is changed, layout information stored in a database for a display element to be changed is changed, and thus, the screen layout can be easily changed.

According to the display control method of the present invention, layout information about each screen layout is separated into a plurality of display elements, and is stored in a plurality of databases for the respective display elements in association with a language selection flag. When a language selection flag is acquired, layout information appropriate to the acquired language selection flag is acquired from each database, and a display device is controlled such that display information is displayed based on the acquired layout information. When the layout information is stored in the plurality of databases, the layout information is stored in at least an alignment/progression database and a component position database. The alignment/progression database stores alignment information and progression information. The component position database stores component position information.

As described above, layout information appropriate to the language selection flag is acquired from the databases provided for the respective display elements. The display device is controlled such that display information is displayed based on the acquired layout information. By this, by changing the language selection flag, all pieces of layout information for each display element can be changed at once. Therefore, a screen layout can be easily designed. In addition, when a screen layout is changed, layout information stored in a database for a display element to be changed is changed, and thus, the screen layout can be easily changed.

The object, features, modes, and advantages of the present invention will become more clear by the following detailed description and accompanying drawings.

### BRIEF DESCRIPTION OF DRAWINGS

FIG. 1 is a block diagram showing a configuration of a display control apparatus 1 which is a first embodiment of the present invention.

FIG. 2 is a block diagram showing a configuration of a display control apparatus 3 which is a second embodiment of the present invention.

FIG. 3 is a block diagram showing a hardware configuration of the display control apparatus 3 of the second embodiment of the present invention.

FIG. 4 is a diagram showing an example of layout information stored in an alignment/progression DB 14.

FIG. 5 is a diagram showing an example of layout information stored in an image DB 36.

FIG. 6 is a diagram showing an example of layout information stored in a character string DB 37.

FIG. 7 is a diagram showing an example of layout information stored in a component position DB 15.

FIG. 8 is a diagram showing an example of a non-Arabic text component.

FIG. 9 is a diagram showing an example of an Arabic text component.

FIG. 10 is a diagram showing an example of non-Arabic screen display.

FIG. 11 is a diagram showing an example of Arabic screen display.

FIG. 12 is a diagram showing an example of actual non-Arabic screen display.

FIG. 13 is a diagram showing an example of actual Arabic screen display.

FIG. 14 is a flowchart showing an example of a processing procedure for a display control process of the display control apparatus 3 of the second embodiment of the present invention.

FIG. 15 is a flowchart showing a processing procedure for a layout information acquiring process at step a3 shown in FIG. 14.

FIG. 16 is a flowchart showing a processing procedure for a layout information acquiring process at step a5 shown in FIG. 14.

FIG. 17 is a flowchart showing a processing procedure for a display control process at step a6 shown in FIG. 14.

### DESCRIPTION OF EMBODIMENTS

### First Embodiment

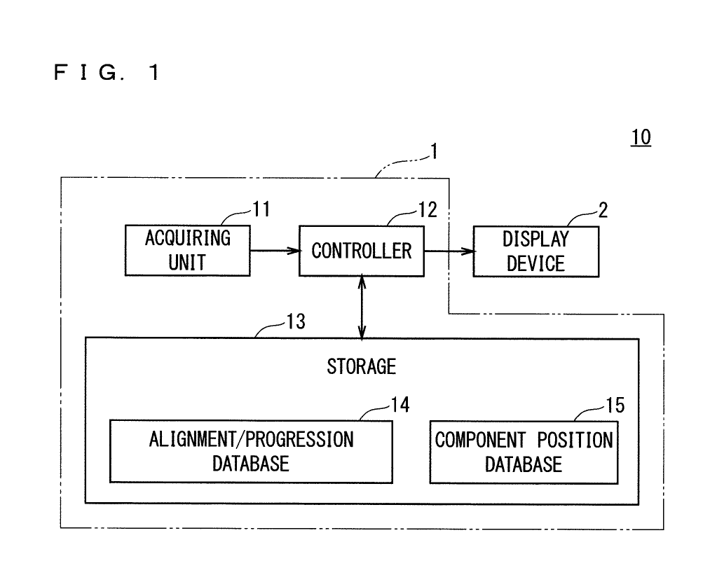

FIG. 1 is a block diagram showing a configuration of a display control apparatus 1 which is a first embodiment of the present invention. The display control apparatus 1 is configured to include an acquiring unit 11, a controller 12, and a storage 13. The storage 13 includes a plurality of databases (abbreviated as DBs) 14 and 15. In the present embodiment, the storage 13 includes an alignment/progression DB 14 and a component position DB 15. In the following description, when the alignment/progression DB 14 and the component position DB 15 are described without particularly distinguishing them from each other, they are simply described as “DBs 14 and 15.”

The display control apparatus 1, together with a display device 2, forms an information providing apparatus 10. The information providing apparatus 10 is configured to include the display control apparatus 1 and the display device 2. The information providing apparatus 10 is configured to be movable with a mobile unit, e.g., a vehicle. Namely, in the present embodiment, the display control apparatus 1 and the display device 2 which form the information providing apparatus 10 are movable. In the present embodiment, the information providing apparatus 10 is implemented by a navigation device having a navigation function that provides route guidance. A display control method which is another embodiment of the present invention is performed by the display control apparatus 1 of the present embodiment.

The display device 2 is capable of displaying, as display information which is information to be displayed, display information with the same content in a plurality of screen layouts for a plurality of different languages. The display device 2 is controlled by the display control apparatus 1, specifically, the controller 12.

The acquiring unit 11 acquires a language selection flag. The language selection flag is a flag indicating which one of the plurality of languages has been selected as a display language which is a language to be displayed on the display device 2.

The language selection flag is acquired, for example, from operation information to be inputted to an operation input device which is provided external to the display control apparatus 1 and which is operated by a user. The configuration is not limited thereto and the language selection flag may be acquired from location information indicating the geographical location of the display device 2.

In the present embodiment, the language selection flag is switched in association with the geographical location of the display device 2. In this case, the language selection flag may be switched, for example, by the user operating the operation input device or may be switched, for example, by determination by the controller 12 based on the geographical location of the display device 2 without a user operation.

When the language selection flag is switched by determination by the controller 12 based on the geographical location of the display device 2, the acquiring unit 11 is configured, for example, such that the acquiring unit 11 acquires location information indicating the geographical location of the display device 2 and when it is determined based on the acquired location information that the display device 2 has moved into an Arabic-speaking country, the acquiring unit 11 switches the language selection flag.

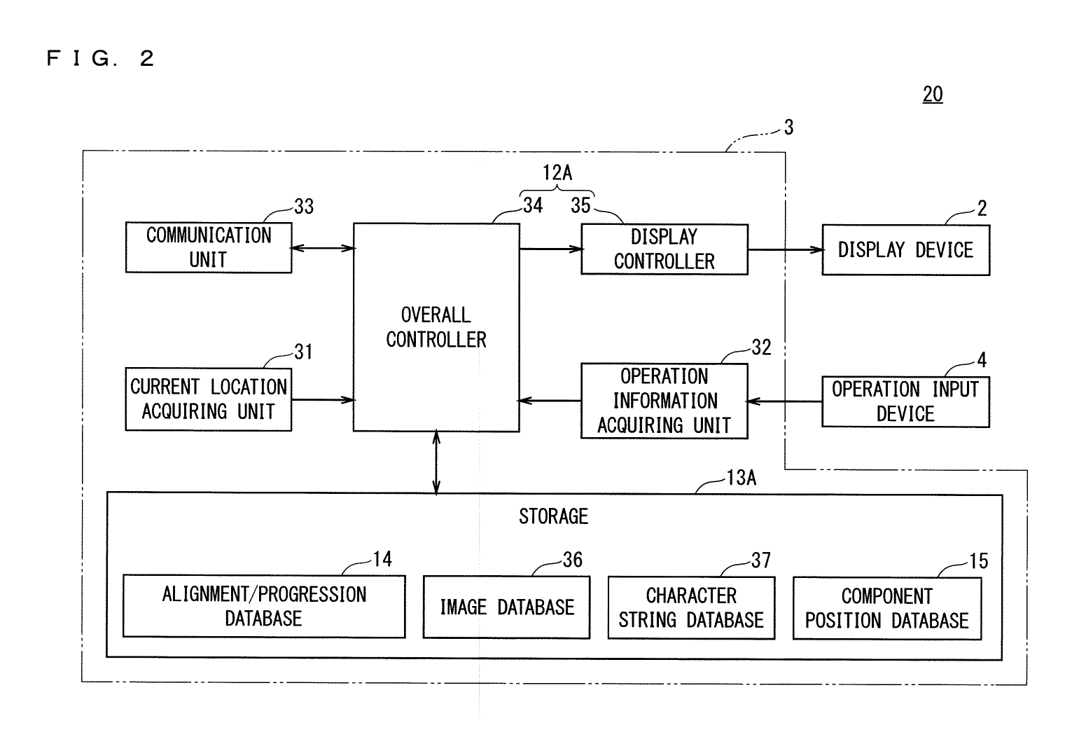

The location information of the display device 2 is acquired, for example, based on a global positioning system (abbreviated as “GPS”) signal from a GPS satellite which is received by a GPS receiving device, map information, and the like. In the present embodiment, since the display device 2 moves with the display control apparatus 1, current location information of the display control apparatus 1 which is acquired by a current location acquiring unit 31 shown in FIG. 2 which will be described later may be used as the location information of the display device 2.

The DBs 14 and 15 in the storage 13 separate layout information which is information about each screen layout into a plurality of display elements forming the screen layout, and store, for the respective display elements, the layout information in association with the language selection flag. The DBs 14 and 15 are provided for the respective display elements.

Specifically, the alignment/progression DB 14 stores alignment information and progression information. The alignment information indicates the position of characters in a text component which is a character display area in which the characters are to be displayed, among the plurality of display elements. The progression information indicates the order of characters in the text component among the plurality of display elements.

The component position DB 15 stores component position information. The component position information indicates the positions, in the screen layouts, of components including the text component, among the plurality of display elements.

The controller 12 acquires layout information appropriate to the language selection flag from each of the DBs 14 and 15, and controls the display device 2 such that the display information is displayed based on the acquired layout information.

The controller 12 is composed of, for example, a Central Processing Unit (CPU) and a memory such as a writable Random Access Memory (RAM). The memory stores a control program. By the CPU executing the control program stored in the memory, a function of the acquiring unit 11 forming the display control apparatus 1 is implemented.

The display device 2 is implemented by, for example, a liquid crystal display. The display device 2 displays an image corresponding to the display information on a display screen of the display device 2, based on an instruction provided from the controller 12.

According to the present embodiment, layout information appropriate to the language selection flag is acquired from the DBs 14 and 15 provided for the respective display elements in the storage 13. The display device 2 is controlled by the controller 12 such that display information is displayed based on the acquired layout information. Since the display control apparatus 1 of the present embodiment is configured in the above-described manner, by changing the language selection flag, all pieces of layout information for each display element can be changed at once. Therefore, a screen layout can be easily switched to one appropriate to a display language.

In addition, when a screen layout is designed, the design is performed on a per display element basis, and thus, the screen layout can be easily designed. In addition, when a screen layout is changed, layout information stored in a database for a display element to be changed is changed, and thus, the screen layout can be easily changed.

In addition, in the present embodiment, the display device 2 is movable and the language selection flag is switched in association with the geographical location of the display device 2. By this, a screen layout can be easily switched to one suitable for the geographical location of the display device 2, enabling to improve user convenience.

### Second Embodiment

FIG. 2 is a block diagram showing a configuration of a display control apparatus 3 which is a second embodiment of the present invention. The display control apparatus 3, together with a display device 2 and an operation input device 4, forms an information providing apparatus 20. The information providing apparatus 20 is configured to include the display control apparatus 3, the display device 2, and the operation input device 4. The information providing apparatus 20 is configured to be movable with a mobile unit, e.g., a vehicle. In the present embodiment, the information providing apparatus 20 is implemented by a navigation device having a navigation function that provides route guidance.

The display control apparatus 3 of the present embodiment includes the same configurations as the display control apparatus 1 of the first embodiment shown in the above-described FIG. 1 and thus the same configurations are denoted by the same reference signs and common description is omitted. A display control method which is another embodiment of the present invention is performed by the display control apparatus 3 of the present embodiment.

The display control apparatus 3 includes a controller 12A, a storage 13A, a current location acquiring unit 31, an operation information acquiring unit 32, and a communication unit 33. The controller 12A includes an overall controller 34 and a display controller 35. The storage 13A includes a plurality of DBs 14, 15, 36, and 37. Specifically, the storage 13A includes an alignment/progression DB 14, a component position DB 15, an image DB 36, and a character string DB 37. The operation information acquiring unit 32 corresponds to an acquiring unit.

The DBs 14, 15, 36, and 37 in the storage 13A separate layout information about each screen layout into a plurality of display elements and store, for the respective display elements, the layout information in association with a language selection flag. The DBs 14, 15, 36, and 37 are provided for the respective display elements.

The image DB 36 stores image information. The image information is information indicating an image forming a screen layout among the plurality of display elements. The character string DB 37 stores character string information. The character string information is information indicating a character string to be displayed in a text component among the plurality of display elements.

The storage 13A is implemented by a storage device such as a semiconductor memory, e.g., a Secure Digital (SD) memory card. The storage 13A may include a map DB that stores map information.

The current location acquiring unit 31 acquires current location information indicating a current location of the display control apparatus 3. The current location acquiring unit 31 acquires current location information as shown below, for example.

The current location acquiring unit 31 reads map information stored in a map DB (not shown) in the storage 13A through the overall controller 34. The current location acquiring unit 31 acquires a radio wave signal from a GPS satellite (which may be hereinafter referred to as a “GPS signal”) which is received by a GPS receiving unit (not shown). The current location acquiring unit 31 calculates a current location of the display control apparatus 3 using the read map information and the acquired GPS signal. The current location acquiring unit 31 generates current location information indicating the calculated current location.

The current location acquiring unit 31 may be configured, for example, to acquire current location information of the display control apparatus 3 from an external source of the display control apparatus 3 by communication. Specifically, the current location acquiring unit 31 may be configured to acquire current location information of the display control apparatus 3 from a server device external to the display control apparatus 3 through the communication unit 33 and the overall controller 34 via a communication network such as the Internet. The current location acquiring unit 31 provides the acquired current location information to the overall controller 34.

The communication unit 33 is configured to be communicable with an external communication device. For example, the communication unit 33 is configured to be communicable with a server device external to the display control apparatus 3 via a communication network such as the Internet.

The operation input device 4 includes an operation input unit (not shown) which is operated by a user. The operation input unit includes, for example, operating switches and operating buttons. The operation input device 4 is used when the user inputs information such as numeric information, character information, and information giving an instruction to the display control apparatus 3. When the operation input unit is operated by the user, the operation input device 4 generates operation information according to the user input operation, and provides the operation information to the operation information acquiring unit 32.

The operation input unit of the operation input device 4 may be composed of a touch panel or an audio input device capable of accepting, as input, an audio operation, instead of operating switches and operating buttons. When the operation input unit is composed of a touch panel, the touch panel is installed on a display surface of the display device 2 and detects a user's touch operation and touch position. The touch panel generates operation information according to the detected touch operation and touch position, and provides the operation information to the operation information acquiring unit 32. When the operation input unit is composed of an audio input device, the audio input device recognizes inputted audio. The audio input device generates operation information according to the recognized audio, and provides the operation information to the operation information acquiring unit 32.

The operation information acquiring unit 32 acquires the operation information provided from the operation input device 4. The operation information is information indicating the operation target and content. The operation information includes, for example, one or more pieces of information indicating the type of operation, the number of operations, the duration of an operation, an image serving as an operation target, the display area, amount of display information, display position, and display processing load of the image, the position or area of an operation on the display screen of the display device 2, and the like.

The overall controller 34 is composed of, for example, a CPU and a memory such as a writable RAM. The memory stores a control program. By the CPU executing the control program stored in the memory, the functions of the current location acquiring unit 31, operation information acquiring unit 32, communication unit 33, and display controller 35 forming the display control apparatus 3 are implemented.

The overall controller 34 controls the display controller 35 based on information provided from the storage 13A, the current location acquiring unit 31, the operation information acquiring unit 32, and the communication unit 33. Specifically, the overall controller 34 controls the display controller 35 such that a signal for displaying display information is generated based on layout information acquired from the DBs 14, 15, 36, and 37 in the storage 13A, and is outputted to the display device 2.

The display controller 35 converts the display information provided from the overall controller 34 into a video signal that can be handled by the display device 2, according to a control instruction provided from the overall controller 34. The display controller 35 provides an instruction to display an image represented by the video signal, together with the acquired video signal, to the display device 2.

The display device 2 is implemented by, for example, a liquid crystal display. The display device 2 displays an image represented by the video signal on the display screen, based on the instruction provided from the display controller 35. By this, an image corresponding to the display information is displayed on the display screen of the display device 2.

By doing so, the controller 12A controls the display device 2 such that the display information is displayed based on the acquired layout information.

In the present embodiment, the overall controller 34 has a car navigation function that provides route guidance from a current location to a destination. Namely, the overall controller 34 performs a process for performing map display, a process for displaying a current location, a route search process, a route directing process, a route guidance process, and a facility search process, using vehicle information provided from a vehicle information acquiring unit (not shown) and current location information provided from the current location acquiring unit 31.

In the present embodiment, a language selection flag is acquired by the operation information acquiring unit 32, for example, from operation information inputted to the operation input device 4. The configuration is not limited thereto and a language selection flag may be acquired from location information indicating the geographical location of the display device 2 as in the above-described first embodiment.

In the present embodiment, the language selection flag is switched in association with the geographical location of the display device 2. In this case, the language selection flag may be switched, for example, by the user operating the operation input device 4 or may be switched, for example, by determination by the overall controller 34 based on the geographical location of the display device 2 without a user operation.

When the language selection flag is switched by determination by the overall controller 34 based on the geographical location of the display device 2, the overall controller 34 is, for example, configured such that the overall controller 34 acquires location information indicating the geographical location of the display device 2 and when it is determined based on the acquired location information that the display device 2 has moved into an Arabic-speaking country, the overall controller 34 switches the language selection flag.

The location information of the display device 2 is acquired, for example, based on a GPS signal from a GPS satellite which is received by a GPS receiving device, map information, and the like. In the present embodiment, since the display device 2 moves with the display control apparatus 1, current location information of the display control apparatus 1 which is acquired by the current location acquiring unit 31 may be used as the location information of the display device 2.

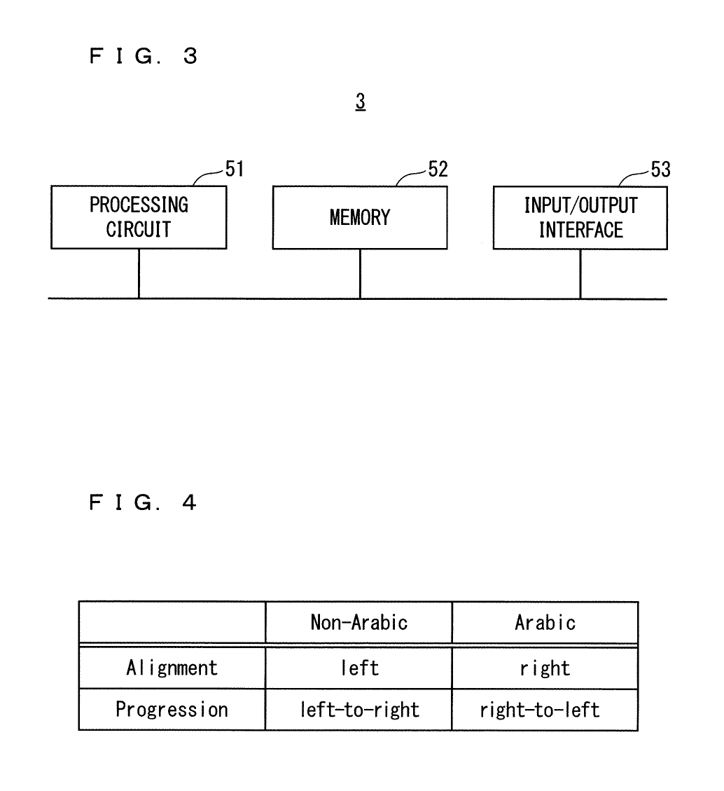

FIG. 3 is a block diagram showing a hardware configuration of the display control apparatus 3 of the second embodiment of the present invention. As shown in FIG. 3, the display control apparatus 3 is configured to include at least a processing circuit 51, a memory 52, and an input/output interface 53.

The display device 2 and the operation input device 4 which are shown in the above-described FIG. 2 are connected to the input/output interface 53. Although in FIG. 2 the operation input device 4 is configured to be provided external to the display control apparatus 3, the configuration may be such that hardware such as the operation input device 4 is disposed in the display control apparatus 3.

The functions of the current location acquiring unit 31, the operation information acquiring unit 32, the communication unit 33, the overall controller 34, and the display controller 35 in the display control apparatus 3 are implemented by the processing circuit 51. Namely, the display control apparatus 3 includes the processing circuit 51 that allows the current location acquiring unit 31 to acquire a current location, allows the operation information acquiring unit 32 to acquire operation information, allows the communication unit 33 to perform communication, allows the overall controller 34 to perform overall control of the display control apparatus 3, and allows the display controller 35 to control the display device 2. The processing circuit 51 is a CPU (also referred to as a central processing unit, a processing device, an arithmetic unit, a microprocessor, a microcomputer, a processor, or a Digital Signal Processor (DSP)) that executes programs stored in the memory 52.

The functions of the operation information acquiring unit 32, the communication unit 33, the overall controller 34, and the display controller 35 are implemented by software, firmware, or a combination of software and firmware. The software and firmware are described as programs and the programs are stored in the memory 52.

The processing circuit 51 implements the functions of the respective units by reading and executing the programs stored in the memory 52. Namely, the display control apparatus 3 includes the memory 52 for storing programs that consequently cause, when executed by the processing circuit 51, the current location acquiring unit 31 to perform a step of acquiring a current location, the operation information acquiring unit 32 to perform a step of acquiring operation information, the communication unit 33 to perform a step of performing communication, the overall controller 34 to perform a step of performing overall control of the display control apparatus 3, and the display controller 35 to perform a step of controlling the display device 2.

In addition, these programs can also be said to be programs that cause a computer to perform a procedure and a method for processes performed by the current location acquiring unit 31, the operation information acquiring unit 32, the communication unit 33, the overall controller 34, and the display controller 35.

Here, the memory 52 corresponds to, for example, a nonvolatile or volatile semiconductor memory such as a Random Access Memory (RAM), a Read Only Memory (ROM), a flash memory, an Erasable Programmable Read Only Memory (EPROM), or an Electrically Erasable Programmable Read Only Memory (EEPROM), a magnetic disk, a flexible disk, an optical disc, a compact disc, a MiniDisc, or a Digital Versatile Disc (DVD).

Referring back to FIG. 2, the operation information acquiring unit 32 acquires a language selection flag based on the operation information provided from the operation input device 4. The language selection flag indicates which one of a plurality of languages displayable on the display device 2 has been selected as a display language to be displayed on the display device 2. The language selection flag is, for example, a global variable. The global variable is described as, for example, “Language_Type”. For example, when Arabic is selected as a display language, the global variable is set to “1” (Language_Type=1). For example, when a language other than Arabic (which may be hereinafter referred to as “non-Arabic”) is selected as a display language, the global variable is set to zero (0) (Language_Type=0).

FIG. 4 is a diagram showing an example of layout information stored in the alignment/progression DB 14. As shown in FIG. 4, the alignment/progression DB 14 stores alignment information that defines alignment and progression information that defines progression. The contents of alignment information and progression information are stored in rows in an identifiable manner. The alignment information and the progression information are stored such that information used for a screen layout for Arabic and information used for a screen layout for non-Arabic, e.g., Western languages, are stored separately in columns.

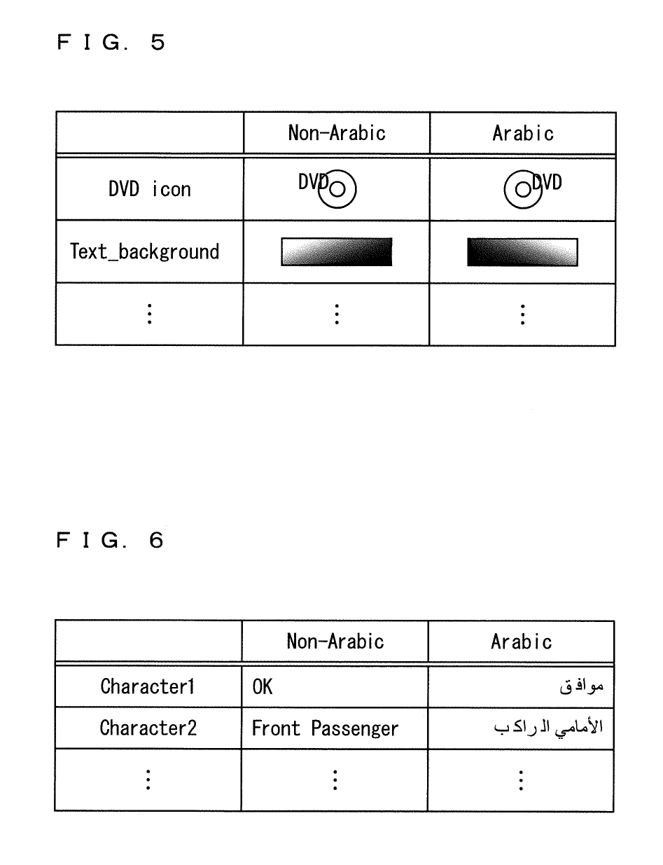

FIG. 5 is a diagram showing an example of layout information stored in the image DB 36. As shown in FIG. 5, the image DB 36 stores image information indicating images to be used for screen layouts. The contents of image information are stored in rows in an identifiable manner. The image information is stored such that information used for a screen layout for Arabic and information used for a screen layout for non-Arabic, e.g., Western languages, are stored separately in columns.

FIG. 6 is a diagram showing an example of layout information stored in the character string DB 37. As shown in FIG. 6, the character string DB 37 stores character string information indicating character strings displayed in text components. The contents of character string information are stored in rows in an identifiable manner. The character string information is stored such that information used for a screen layout for Arabic and information used for a screen layout for non-Arabic, e.g., Western languages, are stored separately in columns.

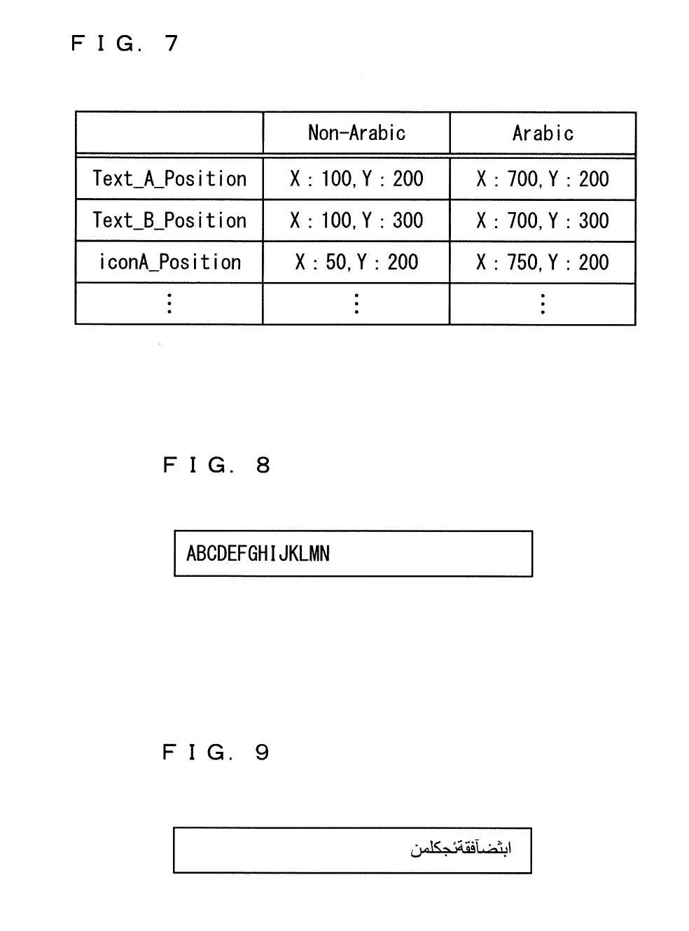

FIG. 7 is a diagram showing an example of layout information stored in the component position DB 15. As shown in FIG. 7, the component position DB 15 stores component position information indicating the positions of components displayed on layout screens, such as text components and icons. The contents of component position information are stored in rows in an identifiable manner. The component position information is stored such that information used for a screen layout for Arabic and information used for a screen layout for non-Arabic, e.g., Western languages, are stored separately in columns.

The display elements stored in the databases shown in FIGS. 4 to 7 are examples. If, in addition to them, there is a display element that requires differentiation between a screen layout for Arabic and a screen layout for non-Arabic, a database that stores the display element is also provided in the storage 13A. It may also be possible that the databases are collectively formed as one database without separating them for each display element, but it is preferred to provide the databases for each display element as in the present embodiment.

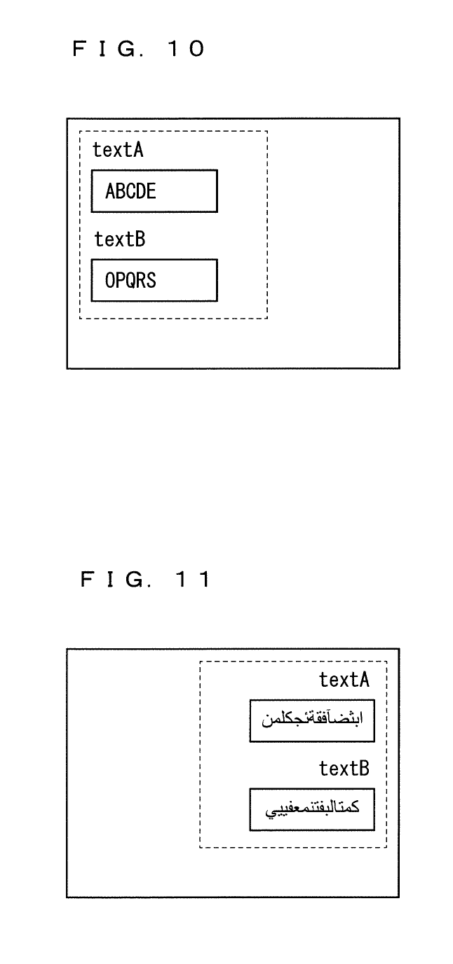

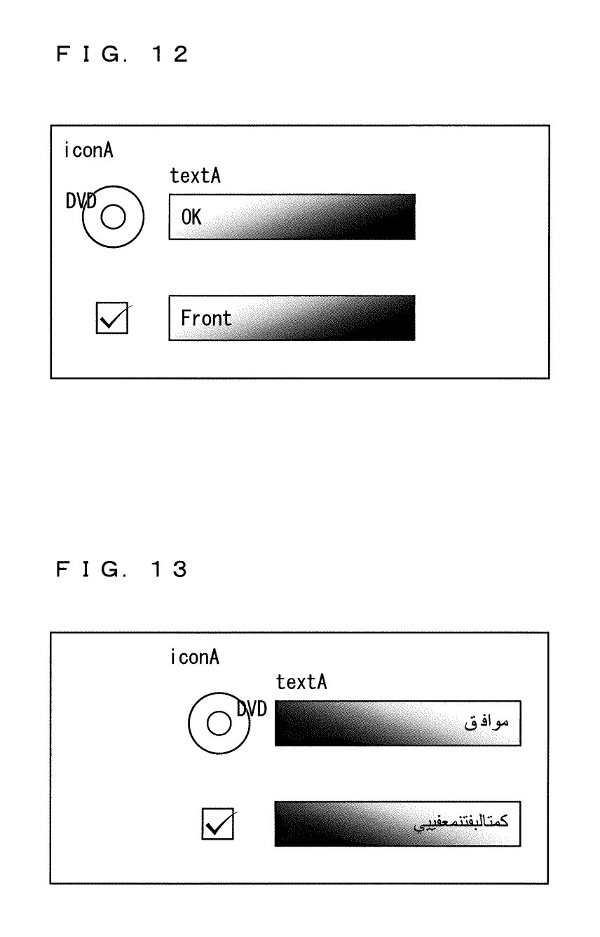

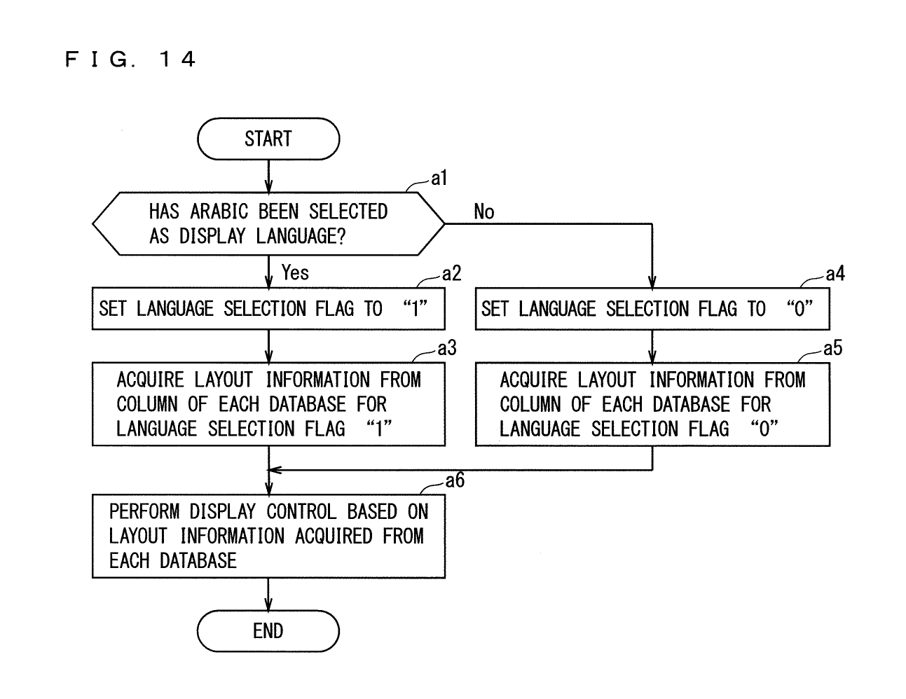

FIGS. 8 to 13 are diagrams showing examples of screen layouts formed based on the layout information for display elements shown in FIGS. 4 to 7. FIG. 8 is a diagram showing an example of a non-Arabic text component. FIG. 9 is a diagram showing an example of an Arabic text component. FIG. 10 is a diagram showing an example of non-Arabic screen display. FIG. 11 is a diagram showing an example of Arabic screen display.

As shown in the above-described FIG. 4, the alignment of a non-Arabic text component is left-aligned and the progression is from left to right. Therefore, for a non-Arabic text component, as shown in FIG. 8, characters are inputted left-aligned and from left to right.

On the other hand, for an Arabic text component, as shown in the above-described FIG. 4, the alignment is right-aligned and the progression is from right to left. Therefore, for an Arabic text component, as shown in FIG. 9, characters are inputted right-aligned and from right to left.

In addition, as shown in FIGS. 10 and 11, on a screen, the display positions of components such as text components are left-right reversed between non-Arabic and Arabic.

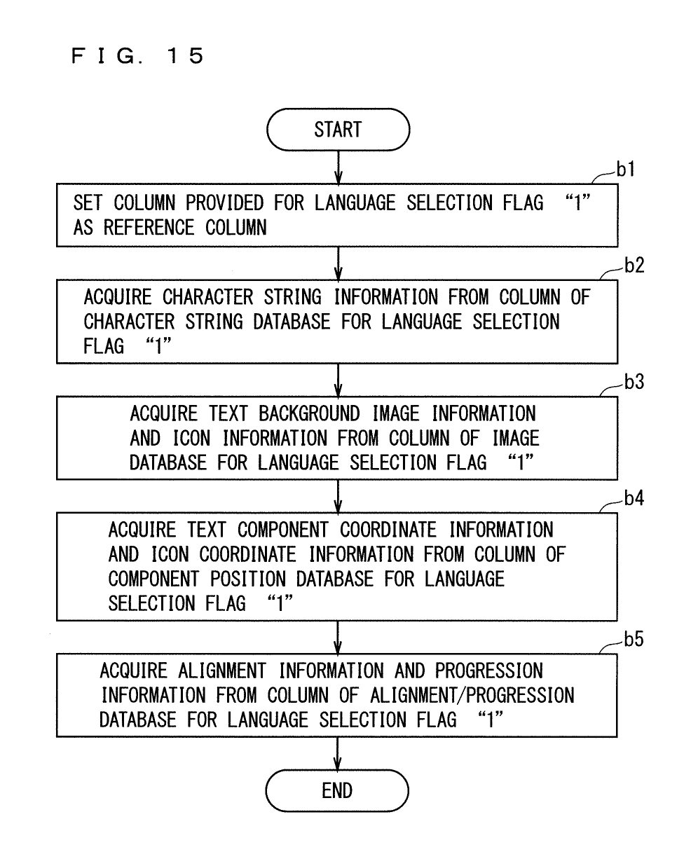

FIG. 12 is a diagram showing an example of actual non-Arabic screen display. FIG. 13 is a diagram showing an example of actual Arabic screen display. As shown in FIGS. 12 and 13, in the actual screen display, too, the display positions of components such as text components are left-right reversed between non-Arabic and Arabic.

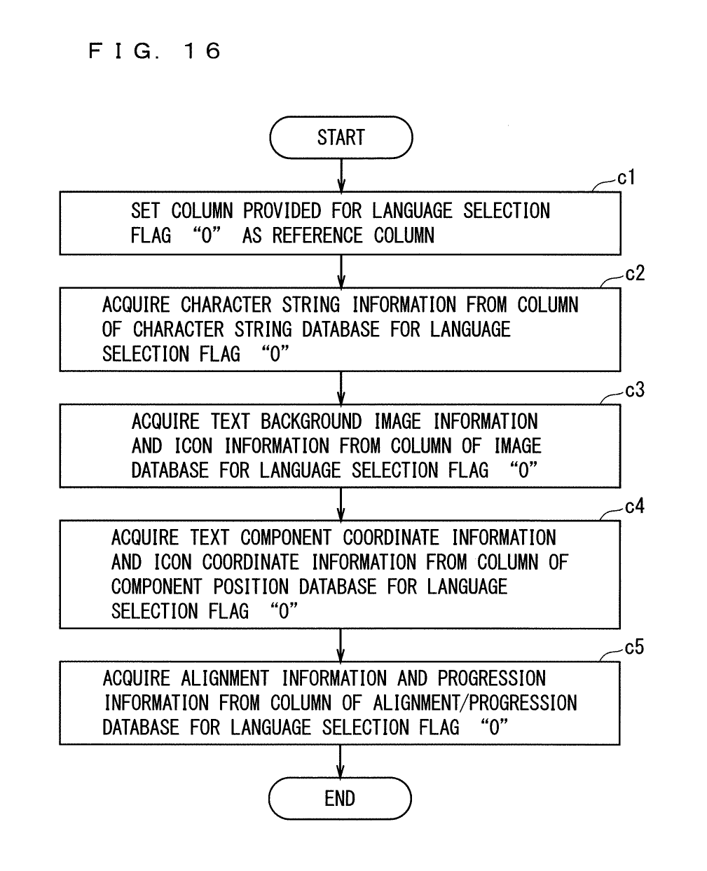

FIG. 14 is a flowchart showing an example of a processing procedure for a display control process of the display control apparatus 3 of the second embodiment of the present invention. The steps of the flowchart shown in FIG. 14 are performed by the operation information acquiring unit 32, the overall controller 34, and the display controller 35 forming the display control apparatus 3. The process of the flowchart shown in FIG. 14 starts when the power to the display control apparatus 3 is turned on, and processing transitions to step a1.

At step a1, the operation information acquiring unit 32 determines whether Arabic has been selected as a display language. If it is determined that Arabic has been selected as a display language, processing transitions to step a2. If it is determined that Arabic has not been selected as a display language, processing transitions to step a4.

At step a2, the operation information acquiring unit 32 sets the language selection flag to “1.” When the process at step a2 is completed, processing transitions to step a3.

At step a3, the overall controller 34 acquires layout information from a column of each database for the language selection flag “1.” When the process at step a3 is completed, processing transitions to step a6.

At step a4, the operation information acquiring unit 32 sets the language selection flag to “0.” When the process at step a4 is completed, processing transitions to step a5.

At step a5, the overall controller 34 acquires layout information from a column of each database for the language selection flag “0.” When the process at step a5 is completed, processing transitions to step a6.

At step a6, the overall controller 34 performs display control based on the layout information acquired from each database, by providing an instruction to the display controller 35. When the process at step a6 is completed, the entire processing procedure ends.

FIG. 15 is a flowchart showing a processing procedure for the layout information acquiring process at step a3 shown in FIG. 14. The process of the flowchart shown in FIG. 15 starts when processing transitions from step a2 to step a3 shown in FIG. 14, and processing transitions to step b1.

At step b1, the overall controller 34 sets a column provided for the language selection flag “1” as a reference column. When the process at step b1 is completed, processing transitions to step b2.

At step b2, the overall controller 34 acquires character string information from a column of the character string database for the language selection flag “1.” When the process at step b2 is completed, processing transitions to step b3.

At step b3, the overall controller 34 acquires text background image information and icon information from a column of the image database for the language selection flag “1.” When the process at step b3 is completed, processing transitions to step b4.

At step b4, the overall controller 34 acquires text component coordinate information and icon coordinate information from a column of the component position database for the language selection flag “1.” When the process at step b4 is completed, processing transitions to step b5.

At step b5, the overall controller 34 acquires alignment information and progression information from a column of the alignment/progression database for the language selection flag “1.” When the process at step b5 is completed, the entire processing procedure ends.

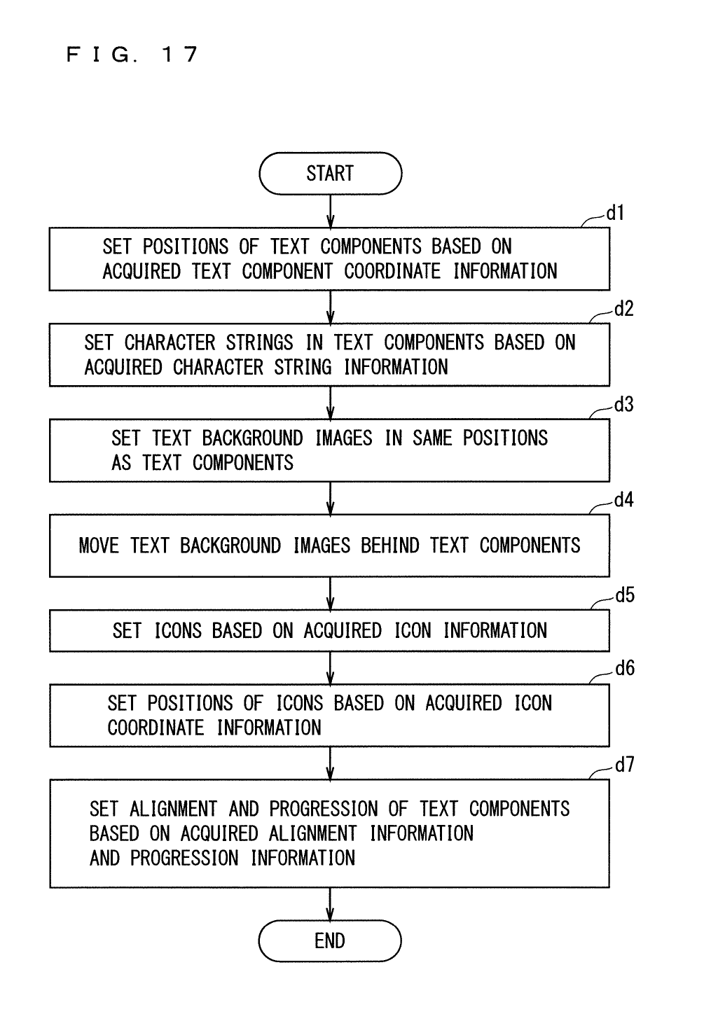

FIG. 16 is a flowchart showing a processing procedure for the layout information acquiring process at step a5 shown in FIG. 14. The process of the flowchart shown in FIG. 16 starts when processing transitions from step a4 to step a5 shown in FIG. 14, and processing transitions to step c1.

At step c1, the overall controller 34 sets a column provided for the language selection flag “0” as a reference column. When the process at step c1 is completed, processing transitions to step c2.

At step c2, the overall controller 34 acquires character string information from a column of the character string database for the language selection flag “0.” When the process at step c2 is completed, processing transitions to step c3.

At step c3, the overall controller 34 acquires text background image information and icon information from a column of the image database for the language selection flag “0.” When the process at step c3 is completed, processing transitions to step c4.

At step c4, the overall controller 34 acquires text component coordinate information and icon coordinate information from a column of the component position database for the language selection flag “0.” When the process at step c4 is completed, processing transitions to step c5.

At step c5, the overall controller 34 acquires alignment information and progression information from a column of the alignment/progression database for the language selection flag “0.” When the process at step c5 is completed, the entire processing procedure ends.

FIG. 17 is a flowchart showing a processing procedure for the display control process at step a6 shown in FIG. 14. The process of the flowchart shown in FIG. 17 starts when processing transitions from step a3 or a5 to step a6 shown in FIG. 14, and processing transitions to step d1.

At step d1, the overall controller 34 sets the positions of text components based on the acquired text component coordinate information. When the process at step d1 is completed, processing transitions to step d2.

At step d2, the overall controller 34 sets character strings in text components based on the acquired character string information. When the process at step d2 is completed, processing transitions to step d3.

At step d3, the overall controller 34 sets text background images in the same positions as the text components. When the process at step d3 is completed, processing transitions to step d4.

At step d4, the overall controller 34 moves the text background images behind the text components.

At step d5, the overall controller 34 sets icons based on the acquired icon information. When the process at step d5 is completed, processing transitions to step d6.

At step d6, the overall controller 34 sets the positions of the icons based on the acquired icon coordinate information. When the process at step d6 is completed, processing transitions to step d7.

At step d7, the overall controller 34 sets the alignment and progression of the text components based on the acquired alignment information and progression information. When the process at step d7 is completed, the entire processing procedure ends.

As described above, according to the present embodiment, layout information appropriate to the language selection flag is acquired from the DBs 14, 15, 36, and 37 provided for the respective display elements in the storage 13A. The display device 2 is controlled by the controller 12A such that display information is displayed based on the acquired layout information. By this, by changing the language selection flag, all pieces of layout information for each display element can be changed at once. Therefore, a screen layout can be easily switched to one appropriate to a display language. In addition, when a screen layout is designed, the design is performed on a per display element basis, and thus, the screen layout can be easily designed. In addition, when a screen layout is changed, layout information stored in a database for a display element to be changed is changed, and thus, the screen layout can be easily changed.

In addition, in the present embodiment, a plurality of languages include Arabic and non-Arabic. The Arabic corresponds to a first language. The non-Arabic corresponds to a language other than the first language. The language selection flag can be set with the first language selection value “1” which is a value indicating that Arabic has been selected, and the non-first language selection value “0” which is a value indicating that a language other than Arabic has been selected. Each of the DBs 14, 15, 36, and 37 separately stores layout information for the language selection flag “1” and layout information for the language selection flag “0.” By this, switching between Arabic display and non-Arabic display can be easily performed.

The display control apparatuses 1 and 3 of the embodiments described above can be applied not only to a navigation device mountable on a vehicle, but also to an information providing apparatus in which a navigation device, a communication terminal device, a server device, and the like, are combined as appropriate. The communication terminal device is, for example, a Portable Navigation Device (PND) having the function of performing communication with a server device, and a portable communication device. The portable communication device is, for example, a mobile phone, a smartphone, and a tablet terminal device.

When, as described above, an information providing apparatus is constructed by combining a navigation device, a communication terminal device, and a server device as appropriate, the components of the display control apparatuses 1 and 3 of the embodiments may be distributed and placed in the devices constructing the information providing apparatus, or may be converged and placed in any one of the devices.

In either of the case in which the components of the display control apparatuses 1 and 3 of the embodiments are thus distributed and placed in the devices constructing the information providing apparatus, and the case in which the components are thus converged and placed in any one of the devices, the same effects as those of the above-described embodiments can be obtained.

Note that in the present invention the embodiments can be freely combined with each other without departing from the spirit and scope of the present invention. Note also that any component of the embodiments may be changed or omitted as appropriate.

Although the present invention has been described in detail, the above description is to be considered in all aspects as illustrative and the present invention is not limited thereto. It will be understood that many unillustrated variants may be considered without departing from the spirit and scope of the present invention.

### REFERENCE SIGNS LIST

1 and 3: display control apparatus

2: display device

4: operation input device

10 and 20: information providing apparatus

11: acquiring unit

12 and 12A: controller

13: storage

14: alignment/progression database

15: component position database

31: current location acquiring unit

32: operation information acquiring unit

33: communication unit

34: overall controller

35: display controller

36: image database

37: character string database

51: processing circuit

52: memory

53: input/output interface

1-4. (canceled)

5. A display control apparatus that controls a display device capable of displaying display information with same content to be displayed, in a plurality of screen layouts for a plurality of different languages, said display control apparatus comprising:
a processor to execute a program;
a memory to store the program which, when executed by the processor, performs processes of,
acquiring a language selection flag indicating which one of said plurality of languages has been selected as a display language to be displayed on said display device; and
acquiring layout information appropriate to said language selection flag from each of a plurality of databases, and controlling said display device such that said display information is displayed based on said acquired layout information; and
a storage to include said plurality of databases, said plurality of databases separating said layout information about each of said screen layouts into a plurality of display elements forming said screen layout, and storing, for said respective display elements, said layout information in association with said language selection flag, wherein
said plurality of databases include:
an alignment/progression database that stores alignment information and progression information among said plurality of display elements, said alignment information indicating a position of characters in a character display area in which said characters are to be displayed, and said progression information indicating order of said characters; and
a component position database that stores component position information among said plurality of display elements, said component position information indicating positions, in said screen layouts, of components including said character display area.

6. The display control apparatus according to claim 5, wherein
said plurality of languages include a first language and a language other than said first language,
said language selection flag can be set with a first language selection value and a non-first language selection value, said first language selection value indicating that said first language has been selected, and said non-first language selection value indicating that said language other than said first language has been selected, and
each of said databases separately stores said layout information for said first language selection value and said layout information for said non-first language selection value.

7. The display control apparatus according to claim 5, wherein
said display device is movable, and
said language selection flag is switched in association with a geographical location of said display device.

8. A display control method that controls a display device capable of displaying display information with same content to be displayed, in a plurality of screen layouts for a plurality of different languages, said display control method comprising:
acquiring a language selection flag indicating which one of said plurality of languages has been selected as a display language to be displayed on said display device;
separating layout information about each of said screen layouts into a plurality of display elements forming said screen layout, and storing said layout information in a plurality of databases for said respective display elements in association with said language selection flag; and
acquiring, when said language selection flag is acquired, said layout information appropriate to said acquired language selection flag from each of said databases, and controlling said display device such that said display information is displayed based on said acquired layout information, wherein
when said layout information is stored in said plurality of databases, said layout information is stored in at least:
an alignment/progression database that stores alignment information and progression information among said plurality of display elements, said alignment information indicating a position of characters in a character display area in which said characters are to be displayed, and said progression information indicating order of said characters; and
a component position database that stores component position information among said plurality of display elements, said component position information indicating positions, in said screen layouts, of components including said character display area.
